(19) United States
(12) Patent Application Publication
(10) Pub. No.: US 2024/0421886 A1
(43) Pub. Date: Dec. 19, 2024

(54) DETERMINATION OF CONCURRENT BEAM FAILURE

(71) Applicant: Nokia Technologies Oy, Espoo (FI)

(72) Inventors: Samuli Heikki TURTINEN, Oulu (FI); Timo KOSKELA, Oulu (FI); Chunli WU, Beijing (CN)

(21) Appl. No.: 18/699,556

(22) PCT Filed: Nov. 3, 2021
(86) PCT No.: PCT/CN2021/128510

§ 371 Date: Apr. 8, 2024

(51) Int. Cl. H04B 7/06; H04L 5/00; H04W 74/0833

(52) U.S. Cl. CPC H04B 7/06964; H04L 5/005; H04W 74/0833

(57) ABSTRACT

Embodiments of the present disclosure relate to devices, methods, apparatuses and computer-readable storage medium for determination of concurrent beam failure. In some example embodiments, a terminal device detects a first beam failure associated with a first set of reference signals used for beam failure detection. The terminal device determines whether a second beam failure associated with a second set of reference signals used for beam failure detection is recovered in response to detecting the first beam failure.

### TECHNICAL FIELD

Embodiments of the present disclosure generally relate to the field of telecommunication, and in particular, to a device, method, apparatus and computer-readable storage medium for determination of a concurrent beam failure.

### BACKGROUND

With development of communication technology, terminal devices may be connected to a serving cell via multiple transmit-receive points (TRP) in the serving cell, to improve the communication capacity, robustness and configuration flexibility of the serving cell. In multiple TRP operation, a terminal device is served by multiple TRPs each configured with a Beam Failure Detection (BFD)-Reference Signal (RS) set associated with beams for the terminal device. Although the robustness of the communication of the terminal device operating in the multiple TRP mode is enhanced, there may be an extreme situation where all the beams associated with multiple TRPs to which the terminal device connects are determined to be failure simultaneously.

### SUMMARY

In general, example embodiments of the present disclosure provide a device, method, apparatus and computer-readable storage medium for a concurrent beam failure.

In a first aspect, there is provided a terminal device. The terminal device comprises at least one processor and at least one memory including computer program code. The at least one memory and the computer program code configured to, with the at least one processor, cause the terminal device to detect a first beam failure associated with a first set of reference signals used for beam failure detection. The first device is further caused to determine whether a second beam failure associated with a second set of reference signals used for beam failure detection is recovered in response to detecting the first beam failure.

In a second aspect, there is provided a method implemented in a terminal device. In the method, the terminal device detects a first beam failure associated with a first set of reference signals used for beam failure detection. After detecting the first beam failure, the terminal device determines whether a second beam failure associated with a second set of reference signals used for beam failure detection is recovered.

In a third aspect, there is provided an apparatus comprising means for performing the method according to the second aspect.

In a fourth aspect, there is provided computer-readable storage medium having instructions stored thereon. The instructions, when executed on at least one processor, cause the least one processor to perform the method according to the second aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example environment in which example embodiments of the present disclosure can be implemented;

FIG. 2 illustrates a flowchart of an example method implemented at a terminal device in accordance with some embodiments of the present disclosure; and

FIG. 3 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the terms “network device” and “transmit-receive point (TRP)” refers to a device which is capable of providing or hosting a cell or coverage where a further device, for example a terminal device, can communicate with. Examples of a network device include, but not limited to, a Node B (NodeB or NB), an Evolved NodeB (cNodeB or eNB), a next generation eNB (ng-eNB), a ng-eNB-Central Unit (ng-eNB-CU), a ng-eNB-Distributed Unit (ng-eNB-DU), a next generation NodeB (gNB), a gNB-Central Unit (gNB-CU), a gNB-Distributed Unit (gNB-DU), a Remote Radio Unit (RRU), a radio head (RH), a remote radio head (RRH), an Integrated Access and Backhaul (IAB) node, a low power node such as a femto node or a pico node, a Transmit-Receive Point (TRP), and the like. In some communication systems, the network device may consist of multiple separate entities, for example, in NTN system, the network device may be consist of radio frequency part located in satellites or drones, and inter-frequency/base band part located in ground stations.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, devices for Integrated Access and Backhaul (IAB), or image capture devices such as digital cameras, gaming devices, music storage and playback appliances, or Internet appliances enabling wireless or wired Internet access and browsing and the like. Herein, the term “terminal device” can be used interchangeably with a UE.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects.

As mentioned above, in the multiple TRP operation, a terminal device may communicate with a serving cell via multiple TRPs. When a beam failure associated with a set of reference signal(s) occurs or is detected for only one TRP, the communication of the terminal device may not be interrupted, or the terminal device may not initiate a random access procedure. This is because the terminal device may continue the communication with the serving cell via other TRPs. The terminal device may report the beam failure associated with the first TRP to the network. Then, for example, the failed TRP may be re-configured by the network to recover from this beam failure.

However, there may be an extreme situation where the terminal device simultaneously detects concurrent beam failures for all TRPs serving the terminal device. For instance, the TRPs serving the terminal device may be provided by a single serving cell (sometimes referred as multiple TRP or mTRP operation) or by multiple cells in inter-cell beam management or inter-cell multiple TRP operation.

Example embodiments of the present disclosure provide a scheme of determination of a concurrent beam failure. In this scheme, if a terminal device detects a first beam failure associated with a first set of reference signals for beam failure detection, the terminal device determines whether a second beam failure associated with a second set of reference signals for beam failure detection is recovered. As such, by determining whether a beam failure is recovered, a terminal device determines whether there are still beam failures associated with the sets of reference signals for all the TRPs serving the terminal device.

If the concurrent second beam failure is determined as being recovered (i.e., the second beam failure is no longer active), the terminal device may continue to communicate with the serving cell without further processing or may initiate a recovery procedure for the first beam failure, for example, initiate a Medium Access Control (MAC) Control Element (CE) transmission for Beam Failure Recovery (BFR). If the concurrent second beam failure is determined as being unrecovered (i.e., the second beam failure is still active), the terminal device may initiate a random access procedure or further methods for recovering communication with the serving cell. In this way, the terminal device is able to more accurately determine whether there are concurrent beam failures.

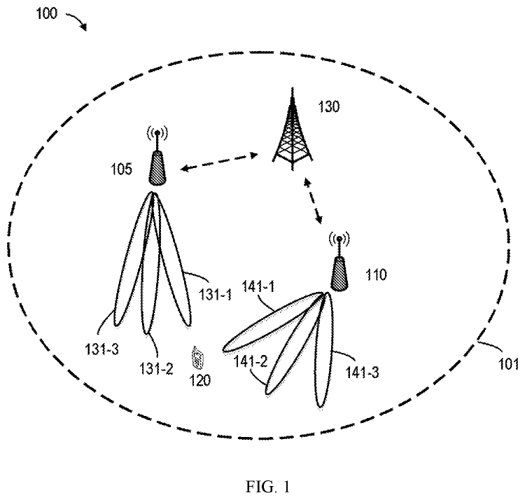

Example embodiments of the present disclosure for determination of concurrent beam failure will be described below with reference to FIGS. 1-3.

FIG. 1 illustrates an example environment 100 in which example embodiments of the present disclosure can be implemented.

The environment 100, which may be a part of a communication network, comprises a serving cell 101, a first TRP 105, a second TRP 110, a terminal device 120 as well as a network device 130. In some embodiments, the serving cell 101 may be a Primary Cell (PCell) or a Primary Secondary Cell (PSCell) or a Special Cell (SpCell). In some embodiments, the serving cell 101 may be a Secondary Cell (SCell).

It is to be understood that the number of TRPs and terminal device is shown in the environment 100 only for the purpose of illustration, without suggesting any limitation to the scope of the present disclosure. In some embodiments, the environment 100 may comprise a further TRP serving the terminal device 120 and/or another terminal device.

In the environment 100, the terminal device 120 may connect to the serving cell 101 provided by the network device 130 via the TRP 105 (also referred as “a first TRP 105” in the following) and the TRP 110 (also referred as “a second TRP 110” in the following). For example, the terminal device 120 may connect to the serving cell 101 via a beam 131-1/131-2/131-3 (collectively referred to as “first beam set 131”) provided by the first TRP 105 and a beam 141-1/141-2/141-3 (collectively referred to as “second beam set 141”) provided by the second TRP 110. Meanwhile, the first TRP 105 transmits a first set of reference signals for beam failure detection associated with the first beam set 131 to the terminal device 120, and the second TRP 110 transmits a second set of reference signals for beam failure detection associated with the second beam set 141 to the terminal device 120, each of the sets of reference signals comprises reference signal associated with individual beam of this set of reference signals, for example, the first set of reference signals comprises one or more reference signals associated with one or more of the beams 131-1, 131-2 and 131-3, respectively. In some embodiments, the reference signal may be Beam Failure Detection (BFD)-Reference Signal (RS). In some embodiments, a set of reference signals, e.g., the first or the second set of reference signals is a set of BFD-RS. In some embodiments, the first set of reference signals and second set of reference signals are associated with the common serving cell 101. In some embodiments, the reference signal may be a Synchronization Signal Block (SSB) or a Channel State Information Reference Signal (CSI-RS). In some embodiments, a set of reference signals, e.g., the first or the second set of reference signals, may comprise one or more reference signals. In some embodiments, a beam may be regarded to as the reference signal in the context of this application. It is to be understood that the terminal device 120 may connect to the serving cell 101 via one or more further beams or reference signals which may not be part of the first or the second set of reference signals. In some embodiments, the terminal device 120 may use the first set of reference signals to determine the occurrence of a beam failure for the first TRP 105 and may use the second set of reference signals to determine the occurrence of a beam failure for the second TRP 110. In some embodiments, a beam failure associated with a set of reference signals may be detected based on a Physical Downlink Control Channel (PDCC) Block Error Rate (BLER) measured on the one or more beams of the set of reference signals. In some embodiments, when the PDCCH BLER goes above a threshold level (e.g., 10%) for a beam or equivalently a reference signal, the beam failure condition applies for the beam or the reference signal. Hence, when the PDCCH BLER goes above the threshold level for all the one or more beams of the set of reference signals, the beam failure may be detected for the set of reference signals. In some embodiments, the threshold level for beam failure detection may be a value configured by the network or a standardized value fixed in the specification.

It is to be understood that the terminal device 120 may also connect to the serving cell 101 via a further beam set provided by a further TRP, in addition to the first and second TRPs 105 and 110. Similarly, the further TRP also transmits a set of reference signals associated with the further beam set. It is also to be understood that the terminal device 120 may also connect to another serving cell via a further beam set provided by a further TRP, in addition to the serving cell 101 and the first and second TRPs 105 and 110. Similarly, the further TRP also transmits a set of reference signals associated with the further beam set.

The communications in the environment 100 may follow any suitable communication standards or protocols, which are already in existence or to be developed in the future, such as Universal Mobile Telecommunications System (UMTS), long term evolution (LTE), LTE-Advanced (LTE-A), the fifth generation (5G) New Radio (NR), Wireless Fidelity (Wi-Fi) and Worldwide Interoperability for Microwave Access (WiMAX) standards, and employs any suitable communication technologies, including, for example, Multiple-Input Multiple-Output (MIMO), Orthogonal Frequency Division Multiplexing (OFDM), time division multiplexing (TDM), frequency division multiplexing (FDM), code division multiplexing (CDM), Bluetooth, ZigBee, and machine type communication (MTC), enhanced mobile broadband (cMBB), massive machine type communication (mMTC), ultra-reliable low latency communication (URLLC), Carrier Aggregation (CA), Dual Connection (DC), and New Radio Unlicensed (NR-U) technologies.

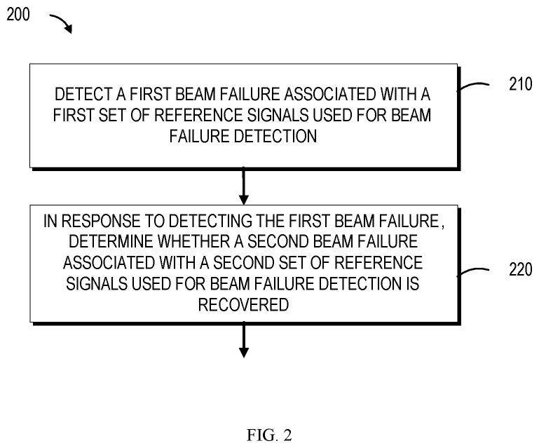

FIG. 2 illustrates a flowchart of an example method implemented at a terminal device in accordance with some embodiments of the present disclosure. For purpose of discussion, the flowchart 200 will be described with reference to FIG. 1.

In the example environment 100, without suggesting any limitations as to the scope of the disclosure, assuming that the terminal device 120 connects to the serving cell 101 via the beam 131-1 in the first beam set 131 provided by the first TRP 105 and the beam 141-1 in the second beam set 141 provided by the second TRP 110.

In some embodiments, the TRP 105 and TRP 110 may also be associated with different serving cells. In this case, the terminal device 120 may communicate with the network in a multiple TRP operation mode of inter cell.

At block 210, the terminal device 210 detects a first beam failure associated with a first set of reference signals used for beam failure detection (i.e. beam failure detection reference signal set). For example, the terminal device detects that all the reference signals in the first set of reference signals transmitted by the first TRP 105 are in failure condition. In some embodiments, in the case that the terminal device 210 transmits the reference signals corresponding to the beams 131-1 and 131-2 to the terminal device, the terminal detects a first beam failure when the terminal device 120 detects that both the reference signals corresponding to the beams 131-1 and 131-2 are in failure condition.

At block 220, after detecting the first beam failure, the terminal device 210 determines whether a second beam failure associated with a second set of reference signals used for beam failure detection is recovered. For example, the terminal device has detected that all the reference signals in the second set of reference signals transmitted by the second TRP 110 are in failure condition. In this case, in response to detecting the first beam failure, the terminal device 120 determines whether this second beam failure, as a concurrent beam failure, is recovered.

In some embodiments, after detecting concurrent beam failures occur on the beam 131-1 and beam 141-1 in both the first and second beam sets 131 and 141, the terminal device 120 determines whether any beam failure in the concurrent beam failures of beams 131-1 and 141-1 is recovered. In some embodiments, the terminal device 120 connects the serving cell 101 via more than two TRPs, after detecting concurrent beam failures on the beams in all beam sets provided by the more than two TRPs, the terminal device 120 determines whether any beam failure in these concurrent beam failures is recovered.

In some embodiments, upon detecting the second beam failure of beam 141-1, the terminal device 120 may transmit a Beam Failure Recovery (BFR) MAC CE to report this second beam failure. For example, the terminal device 120 may transmit the BFR MAC CE to the network device 130 to report the second beam failure on the second set of reference signals or on the second TRP 110. In this case, if the transmitted BFR MAC CE comprises candidate beam information for the second TRP 110, the second beam failure is determined to be unrecovered until the terminal device 120 receives a response for the BFR MAC CE from network. In other words, the second beam failure is determined to be recovered if the terminal device 120 receives the response for the BFR MAC CE which is used to report the second beam failure and comprising candidate beam information associated with the second TRP or the second set of reference signals. For example, the response for the BFR MAC CE from the network may comprise an uplink grant for the same Hybrid Automatic Repeat Request (HARQ process) used to transmit the BFR MAC CE. For example, the response for the BFR MAC CE from the network may comprise a Physical Downlink Control Channel (PDCCH) addressed to Cell Radio Network Temporary Identifier (C-RNTI) indicating uplink grant for a new transmission for the HARQ process used for the transmission of the BFR MAC CE or Truncated BFR MAC CE which contains beam failure recovery information associated with the second TRP 110 or the second set of reference signals. Because of the second beam set 141 can be recovered by the network based on the received BFR MAC CE that comprises the candidate beam information associated with the second TRP or the second set of reference signals, the network may configure a new beam to communicate for the second beam set 141 and recover from the second beam failure.

In some embodiments where the above transmitted BFR MAC CE comprises no candidate beam information associated with the second TRP 110 or the second set of reference signals, the terminal device 120 may determine that the second beam failure is recovered by receiving a reconfiguration associated with the second set of reference signals or an indication of a single TRP mode configured for the terminal device 120.

In some embodiments, the terminal device 120 may determine that the second beam failure is recovered by receiving an indication of a single TRP mode configured for the terminal device 120.

For example, if the terminal device 120 receives an indication of a single TRP mode configured for the terminal device 120, it means that the terminal device 120 may assume only one set of reference signals to be monitored for the serving cell 101. As such, the terminal device 120 may perform the same beam failure recovery procedure as the terminal device operating in single TRP mode, such that the second beam failure may be determined as recovered.

In another example, if the terminal device 120 receives a re-configuration associated with the second set of reference signals, the terminal device 120 may, for example, determine candidate beam associated with the second set of reference signals based on the reconfiguration, such that the second beam failure may be determined as recovered. In some embodiments, the reconfiguration is related to at least one of: a Transmission Configuration Indicator (TCI) state; at least one new reference signal for beam failure detection; and an updated set/list of reference signals for beam failure detection.

In this another example, the terminal device 120 may receive a MAC CE activating at least one new TCI state for a Physical Downlink Control Channel (PDCCH) for at least one of the CORESETs associated with the failed second set of references signals. The association may be determined e.g. through the CORESET association with the CORESETPoolIndex and further the CORESETpoolindex. With the received new TCI state, the second beam failure is determined by the terminal device 120 as recovered.

In this another example, alternatively or in addition, the terminal device 120 may receive an explicit configuration of at least one new reference signal index. For example, terminal device 120 may receive Radio Resource Control (RRC) configuration for a new BFD-RS to be included in the second set of reference signals, i.e. network may assign an SSB resource index or CSI-RS resource index to be included into the second set of reference signals. With the received explicit configuration of at least one new reference signal index, the terminal device 120 may determine a candidate beam associated with the second set of reference signals, and the second beam failure is determined as recovered.

In this another example, alternatively or in addition, the terminal device 120 may receive an updated set/list of reference signals for beam failure detection. As such, the terminal device 120 may determine to evaluate the candidate beams in the updated set/list of reference signals for beam failure detection and consider that the second beam failure is recovered.

In this another example, alternatively or in addition, the terminal device 120 may receive an updated configuration for the second set of reference signals. As such, the terminal device 120 may determine to re-evaluate the second beam failure.

In some embodiments where the above transmitted BFR MAC CE comprises no candidate beam information associated with the second TRP 110 or the second set of reference signals, the second beam failure may be recovered automatically with the changed channel condition. For example, based on the continuous measurement of the failed second set of reference signals (for example, the set of reference signals corresponding to the beam set 141), if a BFI_COUNTER of the second BFD-RS set is reset to zero and/or a beamFailureDetectionTimer associated with the second BFD-RS set expires, then the second beam failure is determined by the terminal device 120 as recovered.

In the case of the terminal device 120 operates in inter-cell multiple TRP operation mode, the concurrent beam failure and the recovery of the beam failure can be determined in the same way as discussed above.

As an example, for inter-cell beam management or inter-cell multiple TRP operation, a terminal device 120 may be configured to communicate with one or more additional/alternative cells (identified by their PCI) that are different from the serving cell (i.e. have a different PCI), while the serving cell connection is maintained (e.g. the serving cell is not changed when the UE is configured to communicate with the additional cell). This additional cell may be also referred as inter-cell beam management cell or inter-cell multiple TRP cell. For beam failure detection, as an example, the UE may monitor beam failure on one or more sets of BFD-RS where one set may include reference signals of an additional/alternative cell/cell with a different PCI. In some examples, the first and second sets of BFD-RS may include the RS associated with a first PCI and a second PCI, respectively. Thus, UE may monitor beam failure on the first cell on the first set of BFD-RS and may monitor beam failure on the second cell on the second set of BFD-RS.

With the above determination of concurrent beam failure, if the second beam failure is still determined as unrecovered, for PCell or PSCell or SpCell, the terminal device 120 may trigger random access procedure for beam failure recovery. For SCell, the terminal device 120 may determine a cell level beam failure for the SCell.

For SpCell, the terminal device 120 may determine to transmit BFR MAC CE wherein it may indicate at least failure of the SpCell. Furthermore the BFR MAC CE may indicate a candidate beam for the failed serving cell. Alternatively, the candidate beam (the octet containing the candidate beam information) may be omitted from the MAC CE and the candidate beam is determined based on the selected SSB (or Downlink Reference signal-DL RS associated with a random access resource) for the random access procedure where the BFR MAC CE is provided. Upon successful recovery (completion of the random access procedure), the terminal device 120 may assume the downlink transmission and/or uplink reception according to the selected DL RS for the random access procedure.

In this way, the link between the terminal device 120 and network can also be recovered in case where candidate beam is not indicated in the BFR MAC CE associated with the second set of reference signals.

In some embodiments, the first set of reference signals is transmitted by a first network device, for instance a first TRP, and the second set of reference signals is transmitted by a second network device, for instance a second TRP, and wherein the first and second sets of reference signals are associated with a common serving cell.

In some embodiments, the serving cell is a primary cell or a primary secondary cell.

In some embodiments, the terminal device 120 is further caused to determine the second beam failure is recovered by: in response to receiving a response for a Beam Failure Recovery (BFR) Medium Access Control (MAC) Control Element (CE) associated with the second beam failure and comprising candidate beam information, determining that the second beam failure is recovered.

In some embodiments, the terminal device 120 is further caused to determine the second beam failure is recovered by: in response to receiving at least one of a reconfiguration associated with the second set of reference signals, or an indication of a single TRP mode configured for the terminal device, determining that the second beam failure is recovered.

In some embodiments, the re-configuration is related to at least one of: a Transmission Configuration Indicator (TCI) state; at least one new reference signal for beam failure detection; and an updated set of reference signals for beam failure detection.

In some embodiments, the terminal device is further caused to initiate a random access procedure in response to determining that the second beam failure is unrecovered.

In some aspects, an apparatus implemented in a terminal device comprises: means for detecting a first beam failure associated with a first set of reference signals used for beam failure detection; and means for determining whether a second beam failure associated with a second set of reference signals used for beam failure detection is recovered in response to detecting the first beam failure.

In some aspects, a terminal device comprises at least one processor; and at least one memory including computer program code; and the at least one memory and the computer program code configured to, with the at least one processor, cause the terminal device to: detect a first beam failure associated with a first set of reference signals used for beam failure detection. The terminal device is further caused to in response to detecting the first beam failure, determine whether a second beam failure associated with a second set of reference signals used for beam failure detection is recovered.

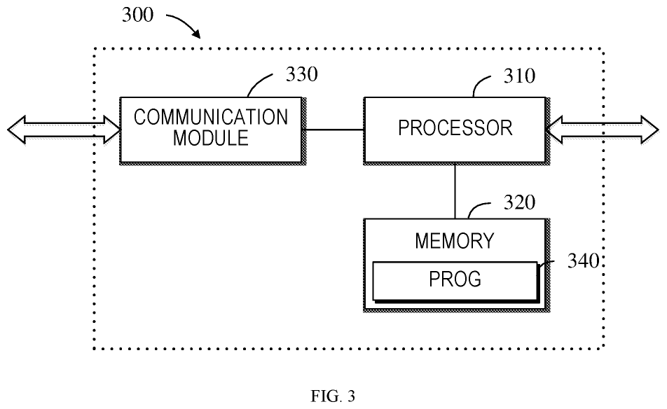

FIG. 3 is a simplified block diagram of a device 300 that is suitable for implementing example embodiments of the present disclosure. The device 300 can be implemented at the terminal device 120 and the TRP 110 as shown in FIG. 1.

As shown, the device 300 includes a processor 310, a memory 320 coupled to the processor 310, a communication module 330 coupled to the processor 310, and a communication interface (not shown) coupled to the communication module 330. The memory 320 stores at least a program 340. The communication module 330 is for bidirectional communications, for example, via multiple antennas or via a cable. The communication interface may represent any interface that is necessary for communication.

The program 340 is assumed to include program instructions that, when executed by the associated processor 310, enable the device 300 to operate in accordance with the example embodiments of the present disclosure, as discussed herein with reference to FIGS. 1 to 2. The example embodiments herein may be implemented by computer software executable by the processor 310 of the device 300, or by hardware, or by a combination of software and hardware. The processor 310 may be configured to implement various example embodiments of the present disclosure.

The memory 320 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 320 is shown in the device 300, there may be several physically distinct memory modules in the device 700. The processor 310 may be of any type suitable to the local technical network, and may include one or more of general purpose computers, special purpose computers, microprocessors, digital signal processors (DSPs) and processors based on multicore processor architecture, as non-limiting examples. The device 300 may have multiple processors, such as an application specific integrated circuit chip that is slaved in time to a clock which synchronizes the main processor.

When the device 300 acts as the terminal device 120, the processor 310 may implement the operations or acts of the first device 120 as described above with reference to FIGS. 1 and 2. When the device 300 acts as the TRP 110, the processor 310 may implement the operations or acts of the TRP 110 as described above with reference to FIGS. 1 and 2. All operations and features as described above with reference to FIGS. 1 to 2 are likewise applicable to the device 300 and have similar effects. For the purpose of simplification, the details will be omitted.

Generally, various example embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of example embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the operations and acts as described above with reference to FIGS. 1 to 6. Generally, program modules include routines, programs, libraries, objects, classes, components, data structures, or the like that perform particular tasks or implement particular abstract data types. The functionality of the program modules may be combined or split between program modules as desired in various example embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable media.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), Digital Versatile Disc (DVD), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular example embodiments. Certain features that are described in the context of separate example embodiments may also be implemented in combination in a single embodiment. Conversely, various features that are described in the context of a single embodiment may also be implemented in multiple example embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

Various example embodiments of the techniques have been described. In addition to or as an alternative to the above, the following examples are described. The features described in any of the following examples may be utilized with any of the other examples described herein.

1-16. (canceled)

17. An apparatus comprising:
at least one processor; and
at least one memory including computer program code,
the at least one memory and the computer program code configured to, with the at least one processor, cause the terminal device to:
detect a first beam failure associated with a first set of reference signals used for beam failure detection; and
in response to detecting the first beam failure, determine whether a second beam failure associated with a second set of reference signals used for beam failure detection is recovered.

18. The apparatus of claim 17, wherein the first set of reference signals is transmitted by a first network device and the second set of reference signals is transmitted by a second network device,
and wherein the first and second sets of reference signals are associated with a common serving cell.

19. The apparatus of claim 18, wherein the serving cell is a primary cell or a primary secondary cell.

20. The apparatus of claim 17, wherein the apparatus is caused to determine the second beam failure is recovered by:
in response to receiving a response for a Beam Failure Recovery Medium Access Control Control Element associated with the second beam failure and comprising candidate beam information, determining that the second beam failure is recovered.

21. The apparatus of claim 17, wherein the apparatus is caused to determine the second beam failure is recovered by:
in response to receiving at least one of a reconfiguration associated with the second set of reference signals, or an indication of a single transmit receive point mode configured for the terminal device, determining that the second beam failure is recovered.

22. The apparatus of claim 21, wherein the re-configuration is related to at least one of:
a Transmission Configuration Indicator state;
at least one new reference signal for beam failure detection; or
an updated set of reference signals for beam failure detection.

23. The apparatus of claim 17, wherein the apparatus is further caused to:
in response to determining that the second beam failure is unrecovered, initiate a random access procedure.

24. A method comprising, by a terminal device:
detecting a first beam failure associated with a first set of reference signals used for beam failure detection; and
in response to detecting the first beam failure, determining whether a second beam failure associated with a second set of reference signals used for beam failure detection is recovered.

25. The method of claim 24, wherein the first set of reference signals is transmitted by a first network device and the second set of reference signals is transmitted by a second network device,
and wherein the first and second sets of reference signals are associated with a common serving cell.

26. The method of claim 25, wherein the serving cell is a primary cell or a primary secondary cell.

27. The method of claim 24, wherein determining whether the second beam failure is recovered comprises:
in response to receiving a response for a Beam Failure Recovery Medium Access Control Control Element associated with the second beam failure and comprising candidate beam information, determining that the second beam failure is recovered.

28. The method of claim 24, wherein determining whether the second beam failure is recovered comprises:
in response to receiving at least one of a reconfiguration associated with the second set of reference signals, or an indication of a single transmit receive point mode configured for the terminal device, determining that the second beam failure is recovered.

29. The method of claim 28, wherein the re-configuration is related to at least one of:
a Transmission Configuration Indicator state;
at least one new reference signal for beam failure detection; or
an updated set of reference signals for beam failure detection.

30. The method of claim 24, further comprising, by the terminal device:
in response to determining that the second beam failure is unrecovered, initiating a random access procedure.

31. A non-transitory computer-readable storage medium having instructions stored thereon, the instructions, when executed on at least one processor, cause the least one processor to:
detect a first beam failure associated with a first set of reference signals used for beam failure detection; and
in response to detecting the first beam failure, determine whether a second beam failure associated with a second set of reference signals used for beam failure detection is recovered.

32. The non-transitory computer-readable storage medium of claim 31, wherein the first set of reference signals is transmitted by a first network device and the second set of reference signals is transmitted by a second network device,
and wherein the first and second sets of reference signals are associated with a common serving cell.

33. The non-transitory computer-readable storage medium of claim 31, wherein the at least one processor is caused to determine the second beam failure is recovered by:
in response to receiving a response for a Beam Failure Recovery Medium Access Control Control Element associated with the second beam failure and comprising candidate beam information, determining that the second beam failure is recovered.

34. The non-transitory computer-readable storage medium of claim 31, wherein the at least one processor is caused to determine the second beam failure is recovered by:
in response to receiving at least one of a reconfiguration associated with the second set of reference signals, or an indication of a single transmit receive point mode configured for the terminal device, determining that the second beam failure is recovered.

35. The non-transitory computer-readable storage medium of claim 34, wherein the re-configuration is related to at least one of:
a Transmission Configuration Indicator state;
at least one new reference signal for beam failure detection; or
an updated set of reference signals for beam failure detection.

36. The non-transitory computer-readable storage medium of claim 31, wherein the at least one processor is further caused to:
in response to determining that the second beam failure is unrecovered, initiate a random access procedure.
